(19) United States
(12) Patent Application Publication
(10) Pub. No.: US 2017/0228931 A1
(43) Pub. Date: Aug. 10, 2017

(54) LIMITED FIELD OF VIEW IN VIRTUAL REALITY

(71) Applicant: GOOGLE INC., Mountain View, CA (US)

(72) Inventors: Evan Hardesty PARKER, Los Altos, CA (US); Dominik Philemon KAESER, Mountain View, CA (US); Aleksandr PALATNIK, Redwood City, CA (US); Adam GLAZIER, Oakland, CA (US)

(21) Appl. No.: 15/018,366

(22) Filed: Feb. 8, 2016

(51) Int. Cl. G06T 19/00

(52) U.S. Cl. CPC G06T 19/006

(57) ABSTRACT

In a virtual reality system, a user may travel from a first virtual location to a second virtual location. During travel, a dynamic virtual animation may be displayed within a portal in the field of view by the user, allowing the user to experience a sensation of traveling from the first virtual location to the second virtual location. A fixed feature may be displayed in the field of view, surrounding the portal. The arrangement and position of the fixed feature may remain fixed while the dynamic virtual animation is displayed within the portal, to provide a stable frame of reference while experiencing the sensation of traveling. The stable frame of reference provided by the fixed feature may mitigate a feeling of disorientation and/or motion sickness during travel due to a mismatch between the dynamic visual experience and the stationary physical experience.

### FIELD

This document relates, generally, to field of view in a virtual reality environment, and in particular, field of view during transport in virtual reality.

### BACKGROUND

A virtual reality (VR) system may generate a three-dimensional (3D) immersive environment. A user may experience this virtual 3D immersive environment through interaction with various electronic devices, such as, for example, a helmet or other head mounted device including a display, glasses or goggles that a user looks through when viewing a display device, gloves fitted with sensors, external handheld devices that include sensors, and other such electronic devices. Once immersed in the virtual 3D environment, the user may move through the virtual environment, and may teleport and/or travel or transport to other areas of the virtual environment.

### SUMMARY

In one aspect, a method may include displaying a first virtual scene corresponding to a first virtual location, detecting a first command to travel to a second virtual location, and traveling from the first virtual location to the second virtual location in response to the first command, including displaying a portal, displaying a fixed feature surrounding the portal, and displaying a dynamic animation of travel from the first virtual location to the second virtual location within the portal, the fixed feature remaining fixed surrounding the portal.

In another aspect, a method may include generating an immersive virtual environment, detecting a first command to travel from a first virtual location to a second virtual location in the virtual environment, and, in response to the first command, displaying a portal in a first portion of a user field of view and a fixed feature in a second portion of the user field of view, the fixed feature surrounding the portal, displaying a dynamic animation of travel from the first virtual location to the second virtual location within the portal until detecting arrival at the second virtual location, a position of the portal and an arrangement and a position of the fixed feature remaining fixed while the dynamic animation is displayed within the portal, and replacing the display of the portal and the fixed feature with a scene corresponding to the second virtual location after detecting arrival at the second virtual location.

In another aspect, a system may include a computing device configured to generate an immersive virtual environment, the computing device including a memory storing executable instructions, and a processor configured to execute the instructions to cause the computing device to generate a virtual environment, detect a first command to travel from a first virtual location to a second virtual location in the virtual environment, and, in response to the first command, replace a first scene corresponding to the first virtual location displayed in a user field of view with a portal and a fixed feature surrounding the portal in the user field of view, and display a dynamic animation of travel from the first virtual location to the second virtual location within the portal, the fixed feature remaining fixed surrounding the portal as the dynamic animation is displayed within the portal.

The details of one or more implementations are set forth in the accompanying drawings and the description below. Other features will be apparent from the description and drawings, and from the claims.

### BRIEF DESCRIPTION OF THE DRAWINGS

FIG. 1 is an example implementation of a virtual reality system including a head mounted display and a handheld electronic device, in accordance with embodiments as described herein.

FIGS. 2A and 2B are perspective views of an example head mounted display, in accordance with embodiments as described herein.

FIG. 3 is a block diagram of a virtual reality system, in accordance with embodiments as described herein.

FIGS. 4A-4E illustrate transport between a first virtual location and a second virtual location in a virtual reality environment, in accordance with embodiments as described herein.

FIG. 5 is a flowchart of a method of transporting in a virtual reality environment, in accordance with embodiments as described herein.

FIG. 6 shows an example of a computer device and a mobile computer device that can be used to implement the techniques described herein.

### DETAILED DESCRIPTION

A user immersed in a 3D virtual environment wearing, for example, a head mounted display (HMD) device may explore the 3D virtual environment and interact with the 3D virtual environment through various different types of inputs including, for example, manipulation of an electronic device separate from the HMD and/or manipulation of the HIVID itself, and/or hand/arm gestures, head movement and/or head and/or eye directional gaze and the like. A user may implement one or more of these different types of interactions to execute a particular action in the virtual environment, including, for example, moving (e.g., transitioning, traveling, teleporting) through the virtual environment from a first location in the of the virtual environment to a second location in the virtual environment. In some instances, an animation of the user's movement (e.g., travel) from the first location to the second location may provide a more realistic virtual experience, allowing the user to remain more connected to the virtual movement (e.g., travel) experience than with an instantaneous move (e.g., teleport) from the first location to the second location. However, the disconnect between the dynamic visual animation experienced by the user, and the lack of actual, physical motion corresponding to the dynamic visual animation, may cause motion sickness and disorientation, detracting from the user's enjoyment of the immersive virtual experience.

A system and method, in accordance with implementations described herein, may facilitate the virtual movement (e.g., travel, transport) of a user from a first location in the virtual environment to a second location in the virtual environment, allowing the user to visually experience the travel from the first location to the second location with little to no disorientation and/or motion sickness. By adjusting and controlling the user's primary field of view (in which the movement from the first location to the second location may be dynamically displayed) and peripheral field of view (which may remain fixed), the user may visually experience the travel from the first location to the second location, rather than instantaneously teleporting from the first location to the second location, enjoying a substantially continuous virtual experience and remaining connected to and present in the virtual experience, with little to none of the disorientation and/or motion sickness sometimes associated with relatively rapid virtual movement.

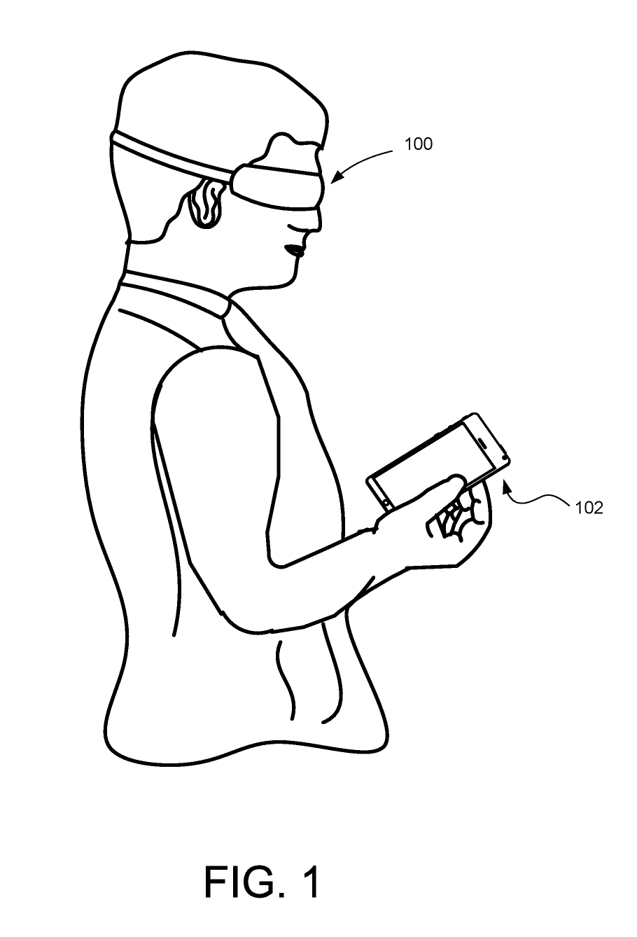

In the example implementation shown in FIG. 1, a user wearing an HMD 100 is holding a portable handheld electronic device 102. The handheld electronic device 102 may be, for example, a smartphone, a controller, a joystick, or another portable handheld electronic device(s) that may be paired with, and communicate with, the HIVID 100 for interaction in the immersive virtual environment generated by the HIVID 100. The handheld electronic device 102 may be operably coupled with, or paired with the HIVID 100 via, for example, a wired connection, or a wireless connection such as, for example, a WiFi or Bluetooth connection. This pairing, or operable coupling, of the handheld electronic device 102 and the HIVID 100 may provide for communication between the handheld electronic device 102 and the HIVID 100 and the exchange of data between the handheld electronic device 102 and the HIVID 100. This may allow the handheld electronic device 102 to function as a controller in communication with the HIVID 100 for interacting in the immersive virtual environment generated by the HIVID 100. That is, a manipulation of the handheld electronic device 102, such as, for example, a beam or ray emitted by the handheld electronic device 102 and directed to a virtual object for selection, and/or an input received on a touch surface of the handheld electronic device 102, or a movement of the handheld electronic device 102, may be translated into a corresponding selection, or movement, or other type of interaction, in the immersive virtual environment generated by the HIVID 100. This may include, for example, a movement of the user from a current virtual environment to a selected destination virtual environment, and in some implementations may also include a scaling of a size of the user based on a user selection, in coordination with the movement to the selected destination virtual environment.

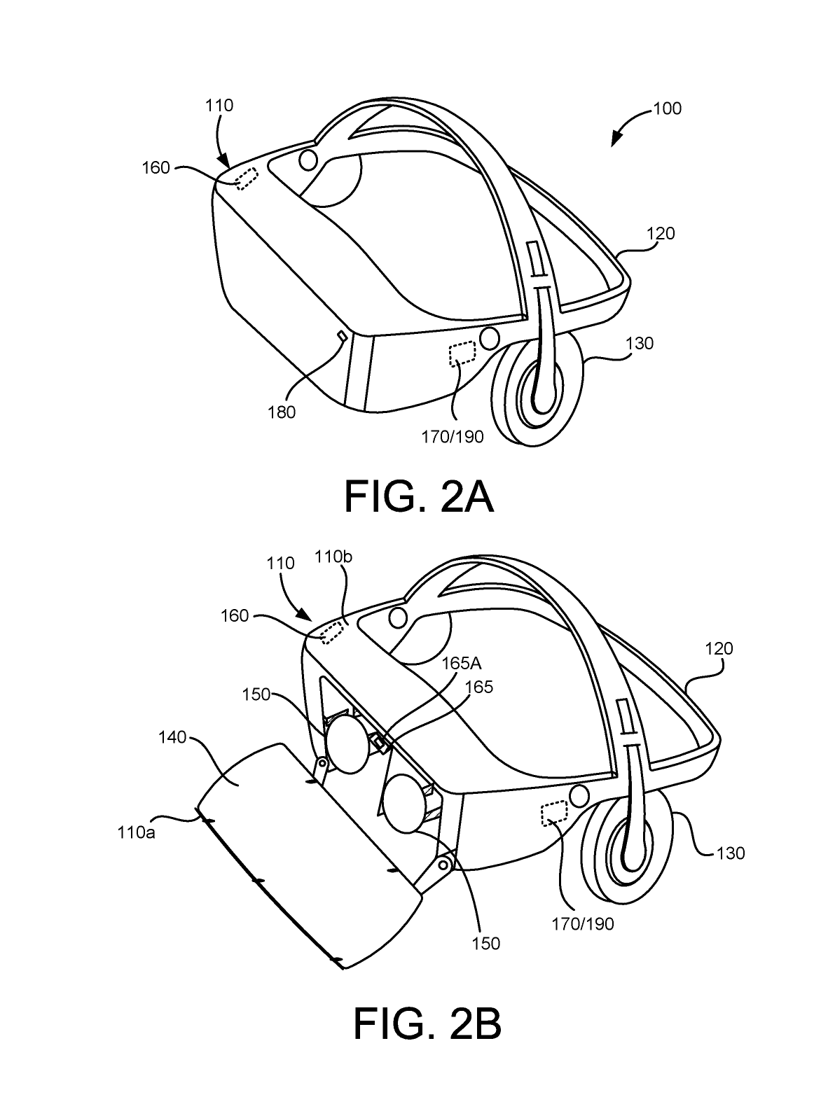

FIGS. 2A and 2B are perspective views of an example HIVID, such as, for example, the HIVID 100 worn by the user in FIG. 1. The HIVID 100 may include a housing 110 coupled to a frame 120, with an audio output device 130 including, for example, speakers mounted in headphones, also coupled to the frame 120. In FIG. 2B, a front portion 110a of the housing 110 is rotated away from a base portion 110b of the housing 110 so that some of the components received in the housing 110 are visible. A display 140 may be mounted on an interior facing side of the front portion 110a of the housing 110. Lenses 150 may be mounted in the housing 110, between the user's eyes and the display 140 when the front portion 110a is in the closed position against the base portion 110b of the housing 110. The HIVID 100 may include a sensing system 160 including various sensors and a control system 170 including a processor 190 and various control system devices to facilitate operation of the HIVID 100.

In some implementations, the HIVID 100 may include a camera 180 to capture still and moving images. The images captured by the camera 180 may be used to help track a physical position of the user and/or the handheld electronic device 102 in the real world, or physical environment relative to the virtual environment, and/or may be displayed to the user on the display 140 in a pass through mode, allowing the user to temporarily leave the virtual environment and return to the physical environment without removing the HIVID 100 or otherwise changing the configuration of the HIVID 100 to move the housing 110 out of the line of sight of the user.

In some implementations, the HIVID 100 may include a gaze tracking device 165 to detect and track an eye gaze of the user. The gaze tracking device 165 may include, for example, an image sensor 165A, or multiple image sensors 165A, to capture images of the user's eyes, for example, a particular portion of the user's eyes, such as, for example, the pupil, to detect, and track direction and movement of, the user's gaze. In some implementations, the HIVID 100 may be configured so that the detected gaze is processed as a user input to be translated into a corresponding interaction in the immersive virtual experience.

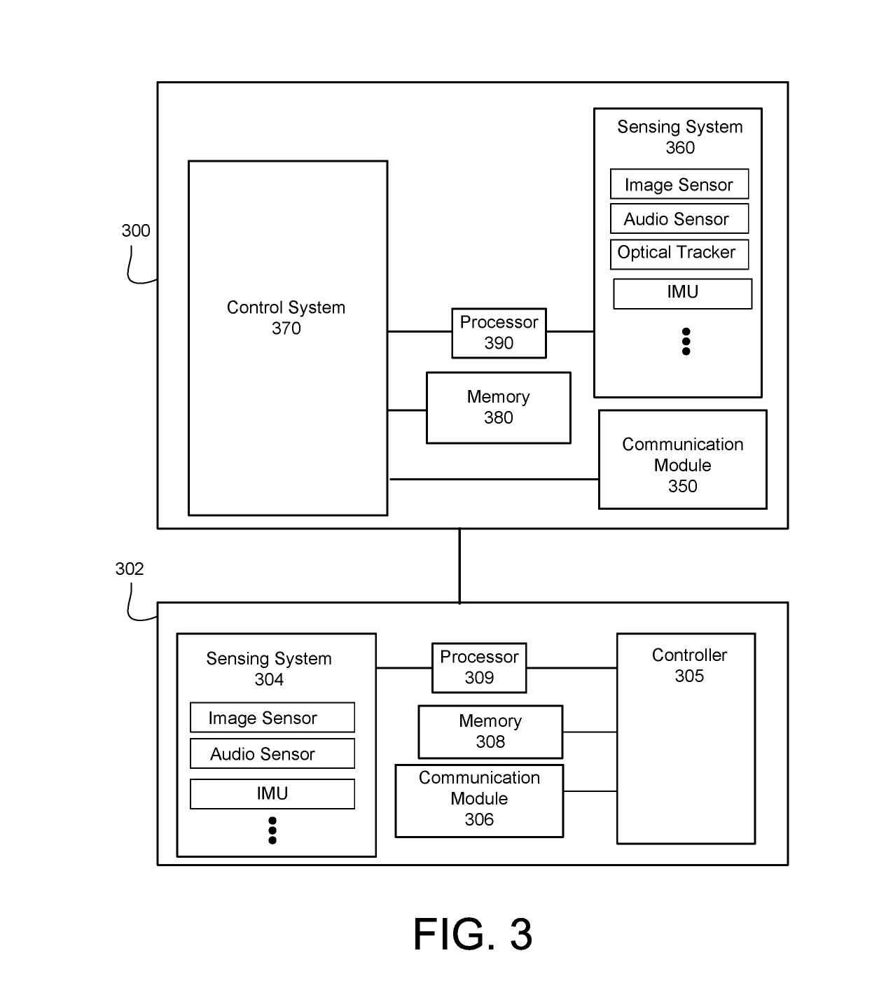

A block diagram of a system, in accordance with implementations described herein, is shown in FIG. 3. The system may include a first electronic device 300 (such as, for example, an HIVID as described above with respect to FIGS. 1 and 2A-2B), and a second electronic device 302 (such as, for example, a handheld electronic device as described above with respect to FIG. 1) in communication with the first electronic device 300 to facilitate user interaction with the immersive virtual environment generated by the first electronic device 300.

The first electronic device 300 may include a sensing system 360 and a control system 370, which may be similar to the sensing system 160 and the control system 170, respectively, shown in FIGS. 2A and 2B. The sensing system 360 may include one or more different types of sensors, including, for example, a light sensor, an audio sensor, an image sensor, a distance/proximity sensor, and/or other sensors and/or different combination(s) of sensors, including, for example, an image sensor positioned to detect and track the user's eye gaze, such as the gaze tracking device 165 shown in FIG. 2B. The control system 370 may include, for example, a power/pause control device, audio and video control devices, an optical control device, a transition control device, and/or other such devices and/or different combination(s) of devices. The sensing system 360 and/or the control system 370 may include more, or fewer, devices, depending on a particular implementation. The elements included in the sensing system 360 and/or the control system 370 may have a different physical arrangement (e.g., different physical location) within, for example, an HMD other than the HIVID 100 shown in FIGS. 2A and 2B. The first electronic device 300 may also include a processor 390 in communication with the sensing system 360 and the control system 370, a memory 380, and a communication module 350 providing for communication between the first electronic device 300 and another, external device, such as, for example, the second electronic device 302.

The second electronic device 302 may include a communication module 306 providing for communication and data exchange between the second electronic device 302 and another, external device, such as, for example, the first electronic device 300. The second electronic device 302 may include a sensing system 304 including, for example, an image sensor and an audio sensor, such as is included in, for example, a camera and microphone, an inertial measurement unit, a touch sensor such as is included in a touch sensitive surface of a handheld electronic device, or smartphone, and other such sensors and/or different combination(s) of sensors. A processor 309 may be in communication with the sensing system 304 and a controller 305 of the second electronic device 302, the controller 305 having access to a memory 308 and controlling overall operation of the second electronic device 302.

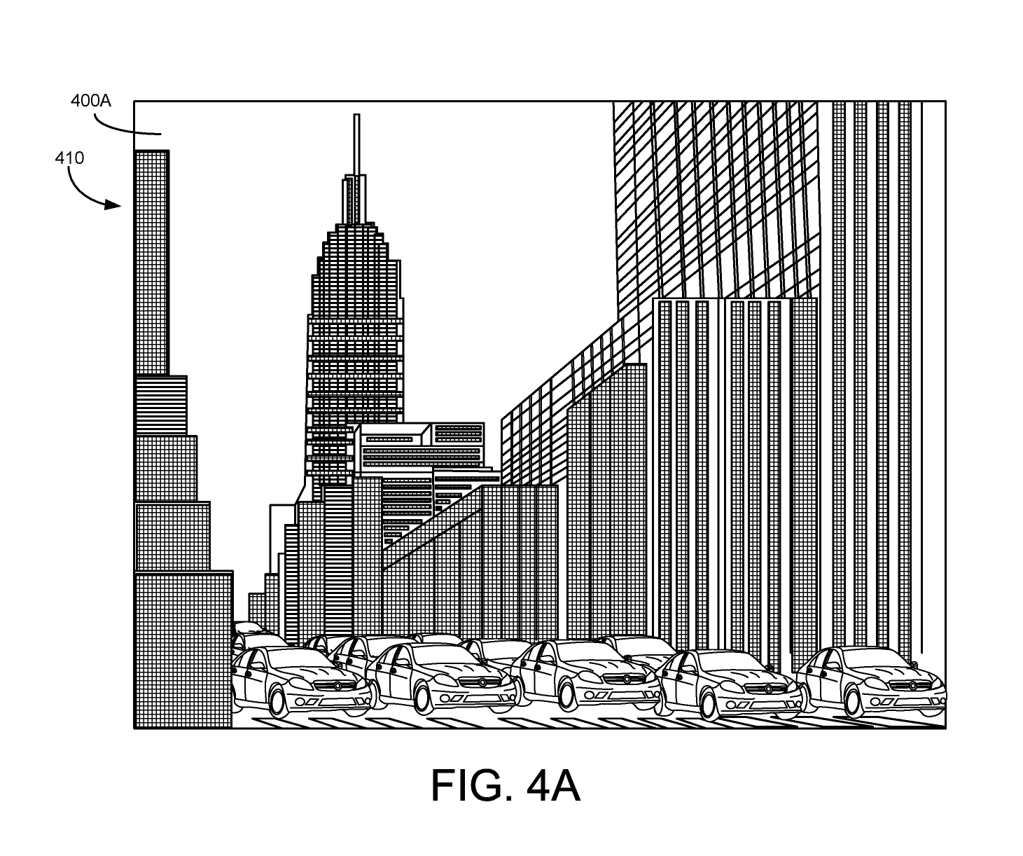

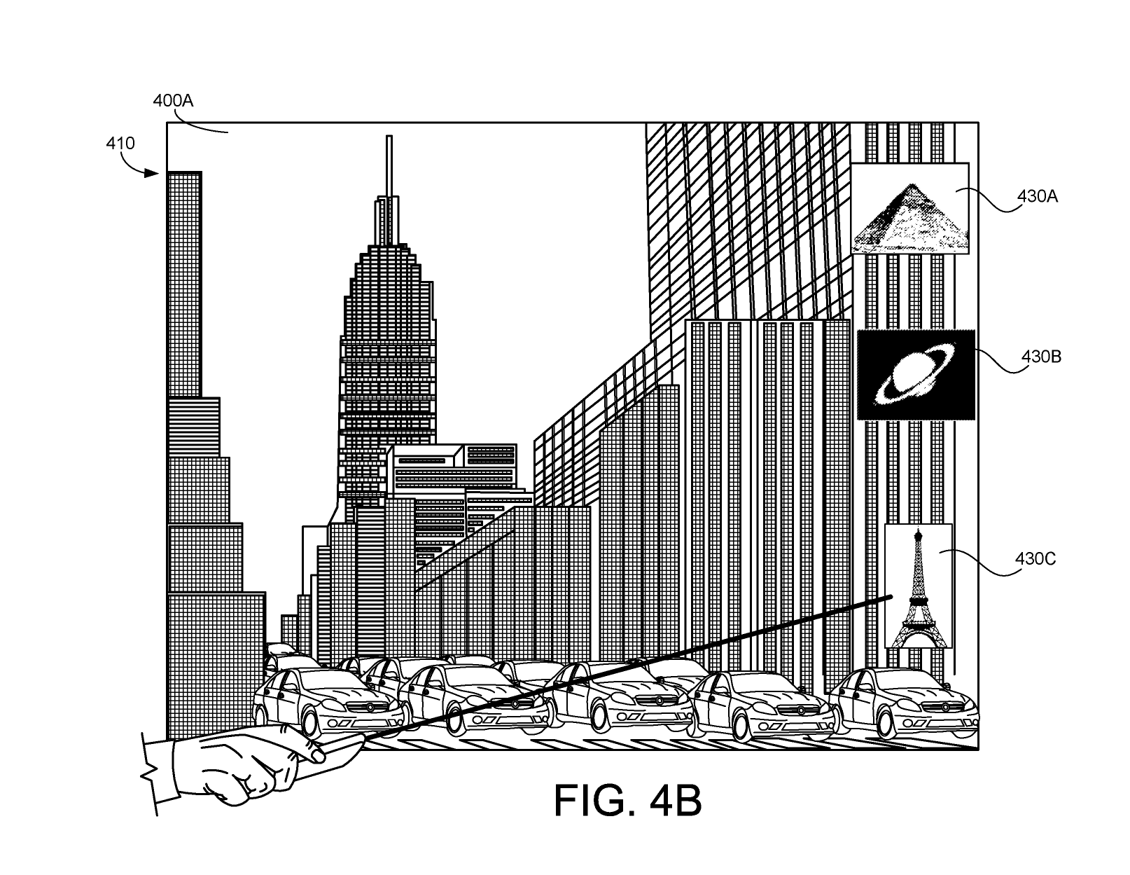

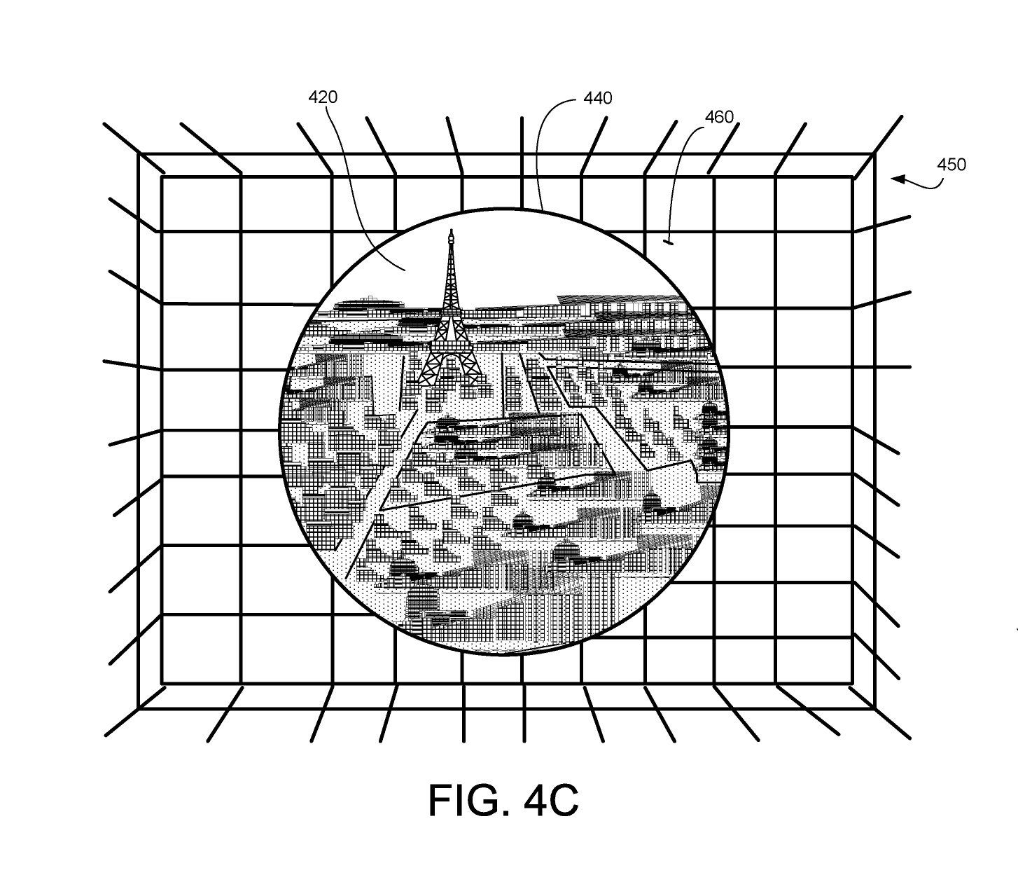

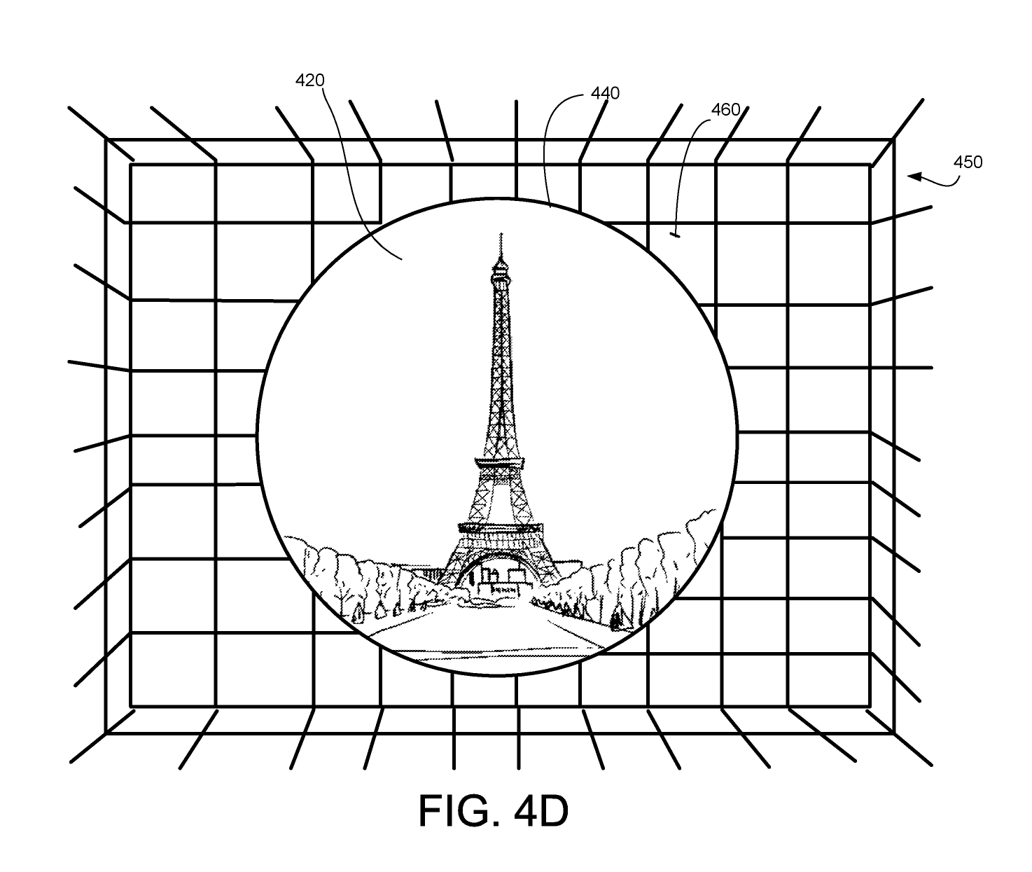

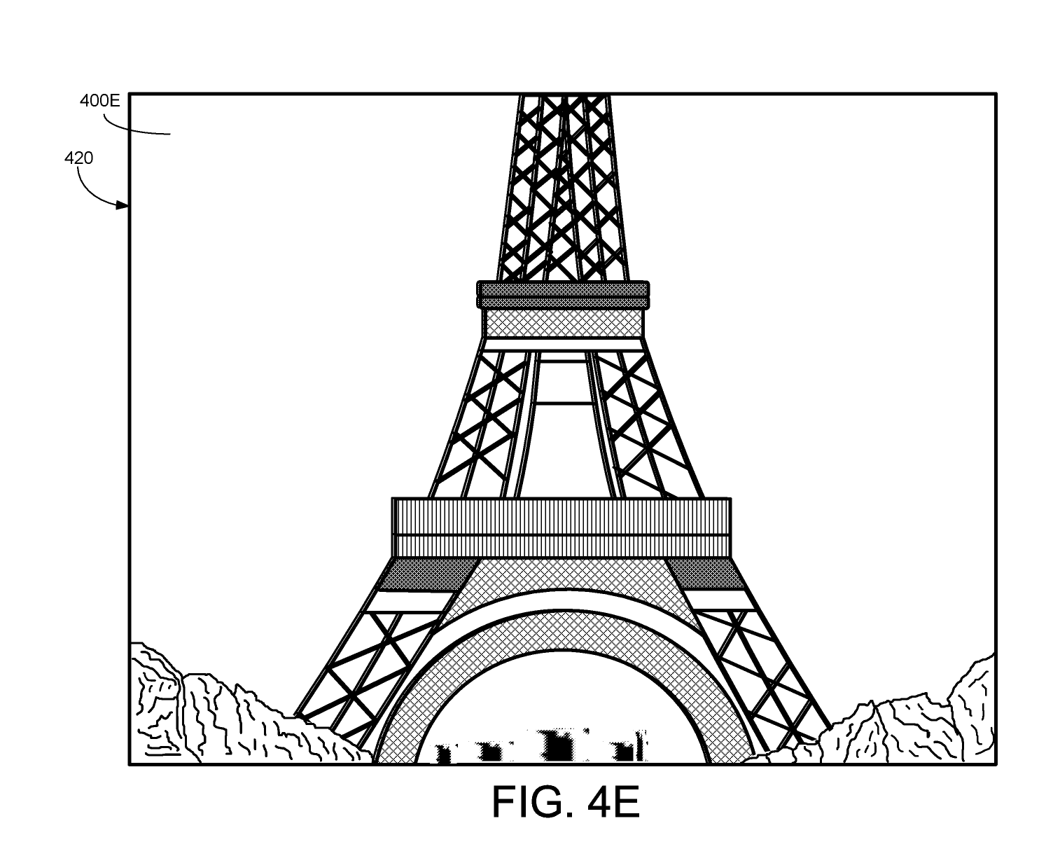

An example implementation, from the viewpoint of a user of a virtual reality system that allows a user to move (e.g., travel, transport) from a first virtual location to a second virtual location while experiencing the movement from the first virtual location to the second virtual location through dynamic visual animation, is shown in FIGS. 4A-4E in accordance with implementations as described herein.

FIG. 4A illustrates an example of virtual scene 400A of a first virtual location 410 within a virtual environment, as viewed by a user. The user may choose to move (e.g., travel, transport) from this first virtual location 410 to a second virtual location 420, for example, by selecting the second virtual location 420 from a menu 430 including menu items 430A, 430B and 430C as shown in FIG. 4B. In the example implementation shown in FIG. 4B, the user directs a selection ray of a handheld electronic device at a menu item 430C corresponding to the second virtual location 420 to select the second virtual location 420. However, this is just one example of how the second virtual location 420 may be selected by the user. The second virtual location 420 may be selected in a variety of other ways.

In response to selection of the second virtual location 420, the system may initiate movement (e.g., transport, travel), from the first virtual location 410 to the second virtual location 420. In one example implementation, a dynamic virtual animation of the travel, or journey, from the first virtual location to the second virtual location, may be displayed within a portal 440 generated by the system for viewing by the user, as shown in FIGS. 4C and 4D. A fixed feature 450, such as, for example, the grid shown in FIGS. 4C and 4D, may be displayed in a peripheral area 460 surrounding the portal 440. As the dynamic virtual animation is displayed within the confines of the portal 440, corresponding to the a relatively rapidly changing animation of the user's journey from the first virtual location 410 to the second virtual location 420, the fixed feature 450 surrounding the portal 440 remains stationary (e.g., fixed) and/or unchanged. The fixed feature 450 may anchor the user's perspective while viewing the dynamic animation through the portal 440, to provide a consistent and stationary frame of reference in the user's peripheral vision. This stationary frame of reference surrounding the rapidly changing dynamic animation displayed in the portal 440 may prevent motion sickness, disorientation and the like which may otherwise be experienced by the user as the user views this type of rapid dynamic animation, without also experiencing physical motion corresponding to the rapid dynamic animation.

FIGS. 4C, 4D and 4E illustrate sequential views of the user's journey, as the user travels from the first virtual location 410 to the selected second virtual location 420. Each image illustrated in the portal 440 in the sequential views illustrated in FIGS. 4C, 4D and 4E is a still image, representing a snapshot at a corresponding intermediate location at FIGS. 4C and 4D, and arrival at the second virtual location 420 at FIG. 4E, along the route of travel between the first virtual location 410 and the second virtual location 420. However, it may be understood that a continuous, virtual animation including a dynamic series of images forming a video stream may be displayed to the user through the portal 440, to provide a realistic representation of movement (e.g., travel, transport) from the first virtual location 410 to the second virtual location 420, and providing the user with the feeling of flying rapidly through the air, or driving rapidly along a road or other type of terrain, or riding rapidly along the water in a watercraft, and the like.

As shown in FIG. 4E, upon arrival at the selected second virtual location 420, the display may revert to a full display format in which the user may be immersed in the scene 400E at the second virtual location 420, no longer bound by the confines of the portal 440, and with the fixed feature 450 no longer displayed in the peripheral area 460 surrounding the portal 440. At this point, the user may resume interaction in the virtual environment, now in the virtual scene 400E at the second virtual location 420. In some implementations, the fixed feature 450 and confines of the portal 440 may be automatically removed by the system upon arrival at the second virtual location, or may automatically fade away upon arrival at the second virtual location 420. In some embodiments, the fixed feature 450 and confines of the portal 440 may be removed by the system in response to a user command after arrival at the second virtual location 420.

The position of the portal 440 may remain fixed with respect to the user's head position, regardless of the user's head movement. That is, as the user moves his/her head, for example, to the left, right, up, down and the like, the portal 440, and the fixed feature 450 surrounding the portal 440, may remain in a fixed position relative to the user's eyes, and to each other, moving together with the user's head movement, regardless of how the user's head moves. This may help maintain the stable point of reference provided by the fixed feature 450, and help prevent motion sickness even in the event of head movement.

In some implementations, movement of the user's head may trigger a corresponding change in the perspective of the travel as viewed by the user through the portal 440. For example, while the position of the portal 440 in the user's field of view and the fixed feature 450 surrounding the portal 440 relative to the user's eyes and/ore nose may remain fixed even as the user's head moves, the user may look in different directions within the dynamic virtual animation displayed within the portal 440 by, for example, moving his/her head in the desired direction. For example, as the user moves (e.g., travels, transports) from the first virtual location 410 to the second virtual location 420, a movement of the user's head in a particular direction may cause the view displayed within the portal 440 to also shift in that direction, changing what the user is able to see in the portal 440 along the user's journey from the first virtual location 410 to the second virtual location 420.

In the example implementation shown in FIGS. 4A-4E, the portal 440 is positioned substantially at the center of virtual visual field displayed to the user, simply for ease of discussion and illustration. In some implementations, the portal 440 may be displayed at other positions within the virtual visual field (e.g., field of view) displayed to the user. However, once established, the position of the portal 440 within the virtual visual field displayed to the user may remain fixed at the established position, until the position of the portal 440 is changed by the user, a new virtual experience is initiated and the like.

In the example implementation shown in FIGS. 4A-4E, the portal 440 is substantially round, simply for ease of discussion and illustration. However, the portal may have various other shapes, such as, for example, oval, square, rectangular, or other closed curve shape. In some implementations, the shape of the portal 440 may be selected by the user. In some implementations, the shape of the portal 440 may be determined based on the first virtual location and/or the second virtual location, and/or a mode of travel between the first virtual location and the second virtual location, and/or distance of travel between the first virtual location and the second virtual location.

In the example implementation shown in FIGS. 4A-4E, the portal 440 has a relatively distinct edge bordering peripheral area 460 and the fixed feature 450 surrounding the portal 440, simply for ease of discussion and illustration. In some implementations, the area in which the edge of the portal 440 transitions into the peripheral area 460 may be gradually faded, or shaded, or blurred, to provide a more gradual transition between the dynamic animation displayed in the portal 440 and the fixed feature 450 in the peripheral area 460.

In the example implementation shown in FIGS. 4A-4E, the fixed feature 450 is illustrated as a grid displayed in the peripheral area 460 surrounding the portal 440, simply for ease of discussion and illustration. The grid is just one example of a fixed feature which may provide the fixed frame of reference to prevent disorientation and/or motion sickness while the dynamic animation is displayed in the portal 440. Other fixed features, having distinct, stationary characteristics, that are clearly distinguishable by the brain, including, for example, a collection of features including a plurality of intersecting lines and/or corners and/or other fixed geometry that does not change, may also provide the fixed frame of reference surrounding the portal 440 to reduce or substantially eliminate disorientation and/or motion sickness. For example, in some implementations, a photorealistic representation of a portion of the room, or real world physical space, in which the system is operating and the user is engaged, may be displayed as the fixed feature in the peripheral area surrounding the portal, with or without a grid overlaid on the representation. In some implementations, a scene from the first virtual location, or a scene from the second virtual location (such as, for example, a city street scene including a plurality of buildings, windows and the like having distinct, fixed, readily distinguishable geometric features), may be displayed as the fixed feature in the peripheral area surrounding the portal, with or without a grid overlaid on the representation.

In some implementations, regardless of a particular contour of the closed curve defining the portal 440, the portal 440 may occupy a fixed portion, or percentage, of the virtual visual space available to the user, and/or a ratio between the area occupied by the portal 440 and the area occupied by the peripheral area 460 surrounding the portal 440 may be a fixed value. For example, in some implementations, the portal 440 may occupy between 70% and 80% of the virtual visual space available to the user, with the peripheral area 460 and fixed feature 450 displayed in the peripheral area 460 occupying the remaining virtual visual space available to the user. In some implementations, the portal 440 may occupy less than 70% of the virtual visual space available to the user, with the peripheral area 460 and fixed feature 450 displayed in the peripheral area 460 occupying the remaining virtual visual space available to the user. In some implementations, the portal 440 may occupy greater than 80% of the virtual visual space available to the user, with the peripheral area 460 and fixed feature 450 displayed in the peripheral area 460 occupying the remaining virtual visual space available to the user.

In the example implementation shown in FIGS. 4A-4E, the dynamic virtual animation displayed in the portal 440 illustrates flying or otherwise traveling through the air at a relatively high speed, from the first virtual location to the second virtual location, simply for ease of discussion and illustration. The illustrated mode of air travel is just one mode in which the dynamic virtual animation may represent travel from the first virtual location to the second virtual location. In some implementations, other modes of travel, such as, for example, in a vehicle on a road, or on the water, or other mode of travel, may also be displayed in the dynamic virtual animation. In some implementations, the mode of travel may be set based on, for example, a distance and/or route of travel between the first virtual location and the second virtual location, or may be selected by the user.

In some implementations, a portion of the virtual visual space occupied by the portal 440, and/or a type of fixed feature 450 to be displayed in the peripheral area 460 surrounding the portal 440, may be set by the user, based on, for example, a user's tolerance level for the dynamic virtual animation during movement (e.g., travel, transport) from the first virtual location 410 to the second virtual location 420/tendency for motion sickness, a mode of travel between the first virtual location 410 and the second virtual location 420, and other user preferences.

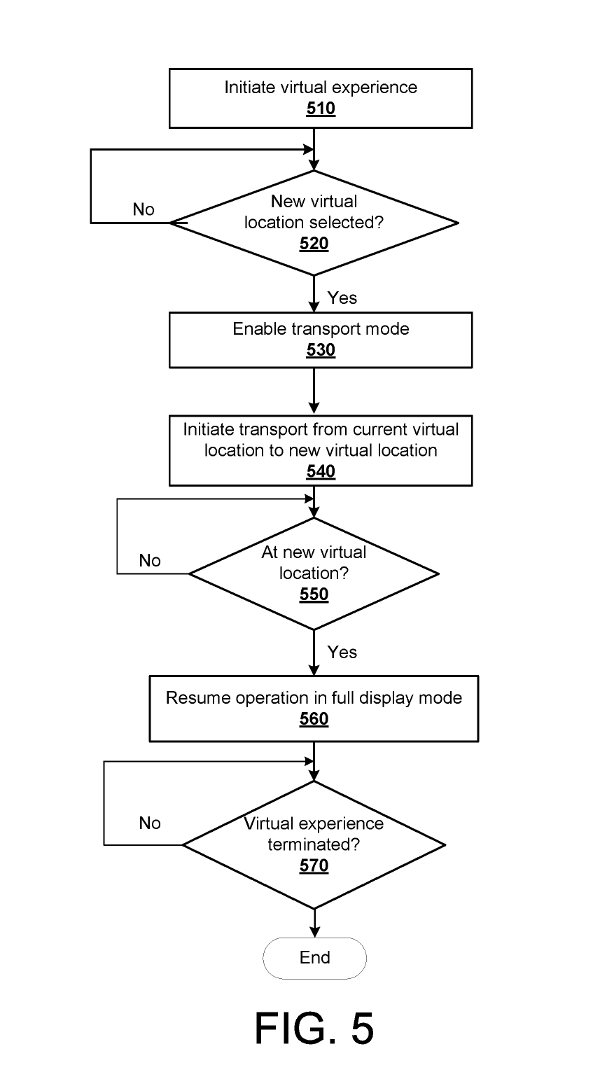

A method of transporting in a virtual reality environment, in accordance with embodiments as described herein, is shown in FIG. 5. An immersive virtual experience is initiated (block 510), and, upon detection of a selection of a new virtual location, indicating a user input to transport from a current virtual location to the newly selected virtual location (block 520), the system may enable a transport mode to facilitate transport from the first virtual location to the second virtual location (block 530). When the transport mode is enabled, the system may access parameters associated with the transport mode, for example, parameters stored in a memory. As noted above, the parameters associated with the transport mode may define, for example, a display format during the transport mode (for example, size and placement of the portal, a fixed feature to be displayed in the peripheral area surrounding the portal), a mode of transportation to be implemented during the transport mode (for example, air travel, road travel, water travel and the like), and other such parameters. The system may then initiate transport from the first virtual location to the second virtual location (block 540). Upon arrival at the second virtual location (block 550), the system may terminate operation in the transport mode, and resume operation in a full display format (block 560), allowing the user to interact in the virtual scene at the second virtual location until the virtual experience is terminated (block 570).

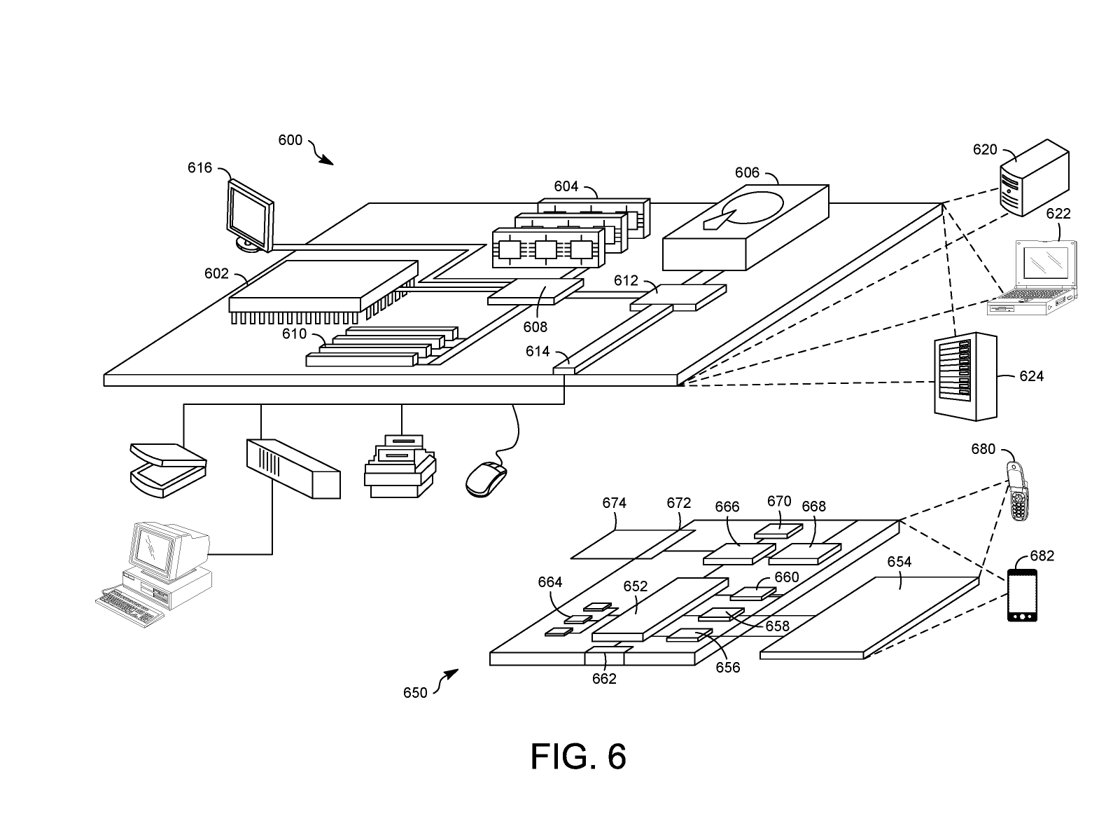

FIG. 6 shows an example of a generic computer device 600 and a generic mobile computer device 650, which may be used with the techniques described herein. Computing device 600 is intended to represent various forms of digital computers, such as laptops, desktops, tablets, workstations, personal digital assistants, televisions, servers, blade servers, mainframes, and other appropriate computing devices. Computing device 650 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 600 includes a processor 602, memory 604, a storage device 606, a high-speed interface 608 connecting to memory 604 and high-speed expansion ports 610, and a low speed interface 612 connecting to low speed bus 614 and storage device 606. The processor 602 can be a semiconductor-based processor. The memory 604 can be a semiconductor-based memory. Each of the components 602, 604, 606, 608, 610, and 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high speed interface 608. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a volatile memory unit or units. In another implementation, the memory 604 is a non-volatile memory unit or units. The memory 604 may also be another form of computer-readable medium, such as a magnetic or optical disk.

The storage device 606 is capable of providing mass storage for the computing device 600. In one implementation, the storage device 606 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 604, the storage device 606, or memory on processor 602.

The high speed controller 608 manages bandwidth-intensive operations for the computing device 600, while the low speed controller 612 manages lower bandwidth-intensive operations. Such allocation of functions is exemplary only. In one implementation, the high-speed controller 608 is coupled to memory 604, display 616 (e.g., through a graphics processor or accelerator), and to high-speed expansion ports 610, which may accept various expansion cards (not shown). In the implementation, low-speed controller 612 is coupled to storage device 606 and low-speed expansion port 614. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. It may also be implemented as part of a rack server system 624. In addition, it may be implemented in a personal computer such as a laptop computer 622. Alternatively, components from computing device 600 may be combined with other components in a mobile device (not shown), such as device 650. Each of such devices may contain one or more of computing device 600, 650, and an entire system may be made up of multiple computing devices 600, 650 communicating with each other.

Computing device 650 includes a processor 652, memory 664, an input/output device such as a display 654, a communication interface 666, and a transceiver 668, among other components. The device 650 may also be provided with a storage device, such as a microdrive or other device, to provide additional storage. Each of the components 650, 652, 664, 654, 666, and 668, are interconnected using various buses, and several of the components may be mounted on a common motherboard or in other manners as appropriate.

The processor 652 can execute instructions within the computing device 650, including instructions stored in the memory 664. The processor may be implemented as a chipset of chips that include separate and multiple analog and digital processors. The processor may provide, for example, for coordination of the other components of the device 650, such as control of user interfaces, applications run by device 650, and wireless communication by device 650.

Processor 652 may communicate with a user through control interface 658 and display interface 656 coupled to a display 654. The display 654 may be, for example, a TFT LCD (Thin-Film-Transistor Liquid Crystal Display) or an OLED (Organic Light Emitting Diode) display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may be provide in communication with processor 652, so as to enable near area communication of device 650 with other devices. External interface 662 may provide, for example, for wired communication in some implementations, or for wireless communication in other implementations, and multiple interfaces may also be used.

The memory 664 stores information within the computing device 650. The memory 664 can be implemented as one or more of a computer-readable medium or media, a volatile memory unit or units, or a non-volatile memory unit or units. Expansion memory 674 may also be provided and connected to device 650 through expansion interface 672, which may include, for example, a SIMM (Single In Line Memory Module) card interface. Such expansion memory 674 may provide extra storage space for device 650, or may also store applications or other information for device 650. Specifically, expansion memory 674 may include instructions to carry out or supplement the processes described above, and may include secure information also. Thus, for example, expansion memory 674 may be provide as a security module for device 650, and may be programmed with instructions that permit secure use of device 650. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, or memory on processor 652, that may be received, for example, over transceiver 668 or external interface 662.

Device 650 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, WiFi, or other such transceiver (not shown). In addition, GPS (Global Positioning System) receiver module 670 may provide additional navigation- and location-related wireless data to device 650, which may be used as appropriate by applications running on device 650.

Device 650 may also communicate audibly using audio codec 660, which may receive spoken information from a user and convert it to usable digital information. Audio codec 660 may likewise generate audible sound for a user, such as through a speaker, e.g., in a handset of device 650. Such sound may include sound from voice telephone calls, may include recorded sound (e.g., voice messages, music files, etc.) and may also include sound generated by applications operating on device 650.

The computing device 650 may be implemented in a number of different forms, as shown in the figure. For example, it may be implemented as a cellular telephone 680. It may also be implemented as part of a smart phone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A method, comprising:
displaying a first virtual scene corresponding to a first virtual location;
detecting a first command to move to a second virtual location; and
moving from the first virtual location to the second virtual location in response to the first command, including:
displaying a portal;
displaying a fixed feature surrounding the portal; and
displaying a dynamic animation of movement from the first virtual location to the second virtual location within the portal, the fixed feature remaining fixed surrounding at least a portion of the portal.

2. The method of claim 1, wherein displaying a dynamic animation of travel from the first virtual location to the second virtual location includes displaying the dynamic animation within the portal until arriving at the second virtual location.

3. The method of claim 2, further comprising:
displaying a second virtual scene corresponding to the second virtual location after arriving at the second virtual location, including no longer displaying the portal and the fixed feature.

4. The method of claim 1, wherein displaying a dynamic animation of movement from the first virtual location to the second virtual location includes displaying the dynamic animation based on at least one mode of movement, of a plurality of modes of movement, from the first virtual location to the second virtual location, the plurality of modes including movement through air, terrestrial movement, or movement along water.

5. The method of claim 1, wherein displaying a portal includes:
displaying the portal at a fixed position within a user field of view, the position of the portal remaining fixed within the field of view until arriving at the second virtual location.

6. The method of claim 5, wherein displaying a fixed feature includes:
displaying the fixed feature in an area of the field of view surrounding the portal, the fixed feature occupying a remaining area of the field of view not occupied by the portal.

7. The method of claim 1, wherein displaying a portal includes:
displaying a closed curve defining the portal within a user field of view, the closed curve occupying a preset area of a user field of view, the dynamic animation being displayed only within the closed curve.

8. The method of claim 7, wherein displaying a fixed feature includes:
displaying a grid in a remaining area of the user field of view not occupied by the closed curve, the preset area occupied by the closed curve defining the portal and the remaining area occupied by the grid filling the user field of view; and
maintaining the grid in a fixed arrangement and a fixed orientation with respect to the closed curve as the dynamic animation is displayed within the closed curve.

9. The method of claim 1, further comprising:
detecting a second command while displaying the dynamic animation within the portal; and
shifting a perspective of the dynamic animation displayed within the portal in response to the second command.

10. The method of claim 9, further comprising:
maintaining a fixed position of the portal within a user field of view and a fixed position and arrangement of the fixed feature in response to the second command.

11. A method, including:
generating an immersive virtual environment;
detecting a first command to move from a first virtual location to a second virtual location in the virtual environment; and
in response to the first command:
displaying a portal in a first portion of a user field of view and a fixed feature in a second portion of the user field of view, the fixed feature surrounding the portal;
displaying a dynamic animation of travel from the first virtual location to the second virtual location within the portal until detecting arrival at the second virtual location, a position of the portal and an arrangement and a position of the fixed feature remaining fixed while the dynamic animation is displayed within the portal;
replacing the display of the portal and the fixed feature with a scene corresponding to the second virtual location after detecting arrival at the second virtual location.

12. The method of claim 11, further comprising:
detecting a second command while displaying the dynamic animation within the portal;
shifting a perspective of the dynamic animation displayed within the portal in response to the second command; and
maintaining the fixed position of the portal and the fixed position and arrangement of the fixed feature in response to the second command.

13. A system, comprising:
a computing device configured to generate an immersive virtual environment, the computing device including:
a memory storing executable instructions; and
a processor configured to execute the instructions to cause the computing device to:
generate a virtual environment;
detect a first command to move from a first virtual location to a second virtual location in the virtual environment; and
in response to the first command,
replace a first scene corresponding to the first virtual location displayed in a user field of view with a portal and a fixed feature surrounding the portal in the user field of view; and
display a dynamic animation of travel from the first virtual location to the second virtual location within the portal, the fixed feature remaining fixed surrounding the portal as the dynamic animation is displayed within the portal.

14. The system of claim 13, wherein an area of the user field of view is defined by a first portion occupied by the portal and a second portion occupied by the fixed feature surrounding the portal.

15. The system of claim 14, wherein the portal is defined by a closed curve positioned at a fixed location in the user field of view.

16. The system of claim 14, wherein the fixed feature includes a grid displayed in the second portion of the user field of view, surrounding the closed curve.

17. The system of claim 14, wherein the fixed feature includes at least one of a plurality of intersecting lines, a plurality of corners, or a plurality of geometric features displayed in the second portion of the user field of view.

18. The system of claim 13, wherein processor is further configured to execute the instructions to cause the computing device to display the dynamic animation of movement from the first virtual location to the second virtual location within the portal until arrival at the second virtual location is detected.

19. The system of claim 18, wherein processor is further configured to execute the instructions to cause the computing device to replace the display of the portal and the fixed feature with a second scene corresponding to the second virtual location displayed in the user field of view after arrival at the second virtual location is detected.

20. The system of claim 13, wherein processor is further configured to execute the instructions to cause the computing device to:
detect a second command while the dynamic animation is displayed within the portal;
shift a perspective of the dynamic animation displayed within the portal in response to the second command; and
maintain the fixed position of the portal within the user field of view and the fixed position and arrangement of the fixed feature in response to the second command.
